(19) United States
(12) Patent Application Publication
(10) Pub. No.: US 2003/0203713 A1
(43) Pub. Date: Oct. 30, 2003

(54) Automatic commodity order processing method and system using the same

(75) Inventor: Toki Onishi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/335,913

(22) Filed: Jan. 3, 2003

(30) Foreign Application Priority Data
Apr. 24, 2002 (JP) 2002-122466

(51) Int. Cl. H04H 9/00

(52) U.S. Cl. 455/2.01

(57) ABSTRACT

An automatic order processing system automatically places an order for a commodity introduced in a broadcast program so as to prevent the commodity from becoming out of stock in a store. The system has a database for registering both a broadcast program data before broadcast and an audience rating data, and a data processor for retrieving the database to extract the commodity introduced in a broadcast program having high audience rating so as to place an order for the commodity automatically. Because the commodity introduced in the broadcast program is extracted by analyzing the program data to perform order processing prior to the program broadcast, the commodity can be provided sufficiently in the store even after the program broadcast.

### BACKGROUND OF THE INVENTION

1. Field of the invention

The present invention relates to an automatic commodity order processing method and a system using the same for automatically placing an order for a desired commodity in a store, and more particularly an automatic commodity order processing method and a system using the same for timely placing an order for a commodity linked with a broadcast program.

2. Description of the Related Art

In a store selling actual commodities therein, it is important in view of store management to manage commodity ordering so as to line up commodities of large demand as many as possible and to avoid commodities from becoming dead stock or out of stock. In particular, when performing commodity order management, it is desirable to predict sales trend on each commodity and to place an order for a commodity of which the sales increase can be expected.

For this purpose, a POS (Point of Sales) system has been introduced in a store such as convenience store, supermarket and volume seller so that sales data can be collected at the time of selling commodities and actual sales results can be totaled. This facilitates to predict sales trend, enabling to place actual orders (including commodity types and amounts) for the following day or the following week.

Also, the sales manager determines commodities of which sales increase is expectable in advance, such as a newly marketed commodity, a commodity tied up with a commercial message, and a commodity having seasonal demand, commodity types according to the information obtained from commodity providers or various research organizations and also orders the commodity type and its amount.

In such a conventional order management method, sales trend is predicted based on actual sales results and information supplied from commodity providers, to place orders for commodities.

Meanwhile, as versatile media programs of mass media are increasing in recent years, various contents of broadcast programs are presented. Some programs remarkably affect consumption tendency. In particular, there are cases that sales amount of a commodity increases after the commodity of interest is particularly introduced in a certain television broadcast program. For example, in regard to a commodity introduced in a health support program or a cooking program (such as soybean flour), a small article used in a program, clothes worn by performers, or a compact disc (CD) including a theme song of the program attracting viewers' interest, there are cases that such commodities bring about remarkable sales increase after the program is broadcast.

However, such a commodity that is particularly introduced or used in a mass media program are not originally specified by the provider or the manufacturer of the commodity as a target of sales promotion. Therefore, in the conventional commodity order management method, it is difficult to forecast large amount of commodities on determining to order.

This raises a problem that a store possibly loses sales opportunity when the sales demand increases to the unexpected extent because of the program broadcast, and as a result the related commodity may become sold out. After the program is broadcast, TV viewers eagerly desire to purchase the related commodity within a short time. If the commodity has been sold out in a certain store, then the viewer goes to other stores to look for a commodity of the same type. It may be rare that the viewers wait until the store concerned completes to supplement the commodity.

### SUMMARY OF THE INVENTION

Accordingly, it is an object of the present invention to provide an automatic commodity order processing method and a system using the method to prevent the commodity from becoming out of stock after the program broadcast.

It is also an object of the present invention to provide an automatic commodity order processing method and a system using the method to place an order in advance for a commodity linked with a broadcast program, the sales amount of which is expected to increase because of the broadcast program contents.

It is also an object of the present invention to provide an automatic commodity order processing method and a system using the method for placing an order automatically for the commodity the sales amount of which is expected to increase after the program broadcast, thus reducing labor of the staff in charge of order processing in a store.

To attain the aforementioned object, an automatic commodity order processing method according to the present invention includes the steps of; storing into a database file both a broadcast program data representing broadcast program contents before broadcast and an audience rating of the program broadcast in the past; retrieving in the database file in advance of the program broadcast and extracting broadcast program contents having high audience ratings; and selecting from the broadcast program contents a commodity of which sales amount is expected to increase because of the program broadcast, to execute order processing for the selected commodity.

Further, an automatic commodity order processing system according to the present invention includes; a database file including a broadcast program data representing broadcast program contents before broadcast and an audience rating of the program broadcast in the past; and a data processor for retrieving in the database file in advance of the program broadcast, extracting broadcast program contents having high audience ratings, selecting from the broadcast program contents a commodity of which sales amount is expected to increase because of the program broadcast, and executing order processing for the selected commodity.

According to the present invention, because a commodity to be introduced in a broadcast program is extracted by program data analysis in advance of the broadcast so as to place an order for the commodity in advance of the program broadcast, the commodity of interest can be provided sufficiently in the store after the program is broadcast. Accordingly, it becomes possible to prevent the commodity from becoming out of stock and to prevent loss of sales opportunity.

Also, because an audience rating data is added to a forecast factor, it becomes possible to obtain more accurate sales forecast. Moreover, because the commodity of which sales increase is expectable can be ordered automatically, it becomes possible to conduct the order job with reduced labor of the staff in charge of order processing.

According to the present invention, preferably the aforementioned extraction step includes the step of regarding the audience rating of the past as an audience rating of the program to be broadcast, and extracting broadcast program contents having higher audience rating than a predetermined threshold. This enables to forecast the commodity of which sales increase is expectable because of the program broadcast more accurately with simple processing.

According to the present invention, preferably the aforementioned storing step includes the step of registering the broadcast program contents, broadcast area and the audience rating data, and also the aforementioned extraction step includes the step of extracting broadcast program contents having high audience rating in a broadcast area corresponding to the area in which the store selling the commodity is located.

Thus, the broadcast area of the program is considered when the commodity introduced in the broadcast program concerned is extracted by program data analysis in advance of the program broadcast and the commodity is ordered in advance of the broadcast. This enables to forecast the sales of the commodity of interest more accurately.

According to the present invention, preferably the aforementioned storing step and extraction step are executed in a head office system, while the aforementioned order processing step is executed in a store system to which the extracted broadcast program contents are distributed from the head office system. This enables to reduce the load of each store, as well as to integrate the database to a single form.

According to the present invention, preferably the aforementioned order processing step includes the step of referring to a stock amount of the commodity stored in a commodity master file, and calculating an order amount of the commodity for placing an order. This enables to calculate the order amount automatically, improving the accuracy of automatic ordering.

According to the present invention, preferably the aforementioned order processing step includes the step of referring to a stock amount of the commodity in a commodity master file provided in a store system, and calculating an order amount of the commodity for placing an order. This enables to calculate the order amount automatically corresponding to stock conditions in each store, improving the accuracy of automatic ordering in each store.

Further scopes and features of the present invention will become more apparent by the following description of the embodiments with the accompanied drawings.

### BRIEF DESCRIPTION OF THE DRAWINGS

FIG. 1 shows a system configuration of one embodiment of the present invention.

FIG. 2 shows a functional block diagram of the system shown in FIG. 1.

FIG. 3 shows an explanation drawing of program master registration and analysis processing provided in the head office system shown in FIG. 2.

FIG. 4 shows a diagram illustrating flow of the program master registration and analysis processing in the head office system shown in FIG. 3.

FIG. 5 shows a diagram illustrating commodity order processing flow in the store systems shown in FIG. 2.

FIG. 6 shows an explanation drawing of a program master file provided in the stores shown in FIG. 3.

FIG. 7 shows an explanation drawing of a commodity master file provided in the stores shown in FIG. 5.

### DETAILED DESCRIPTION OF THE PREFERRED EMBODIMENTS

The preferred embodiment of the present invention is described hereinafter referring to the charts and drawings, wherein like numerals or symbols refer to like parts. An automatic order system, an automatic order processing and other embodiment are described successively. Needless to say, the embodiments of the present invention are not limited to the embodiments described herein.

[Automatic Order System]

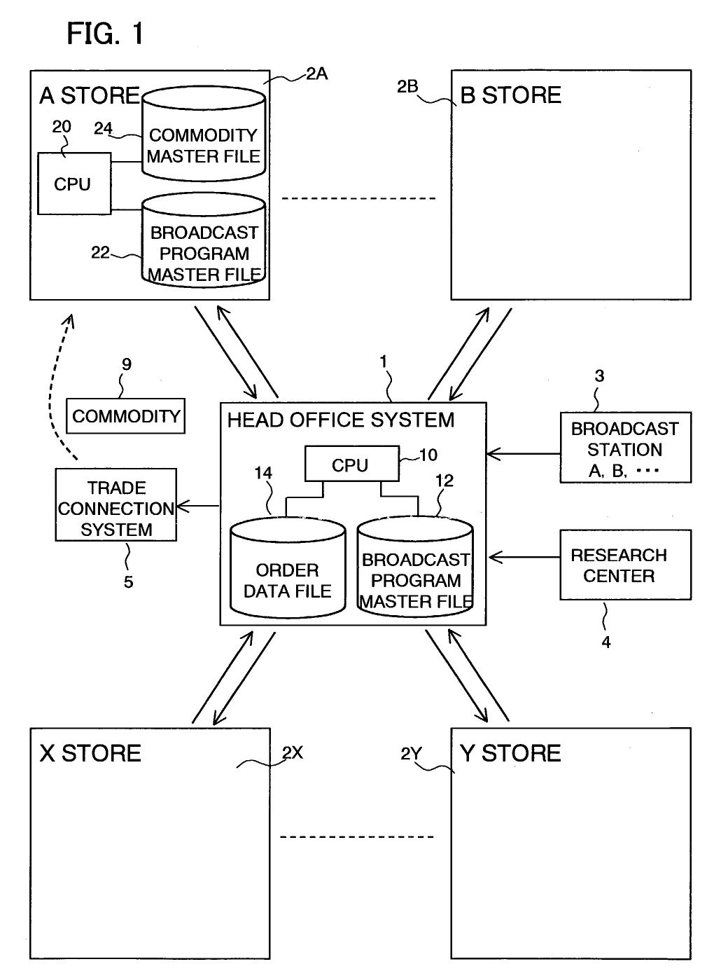

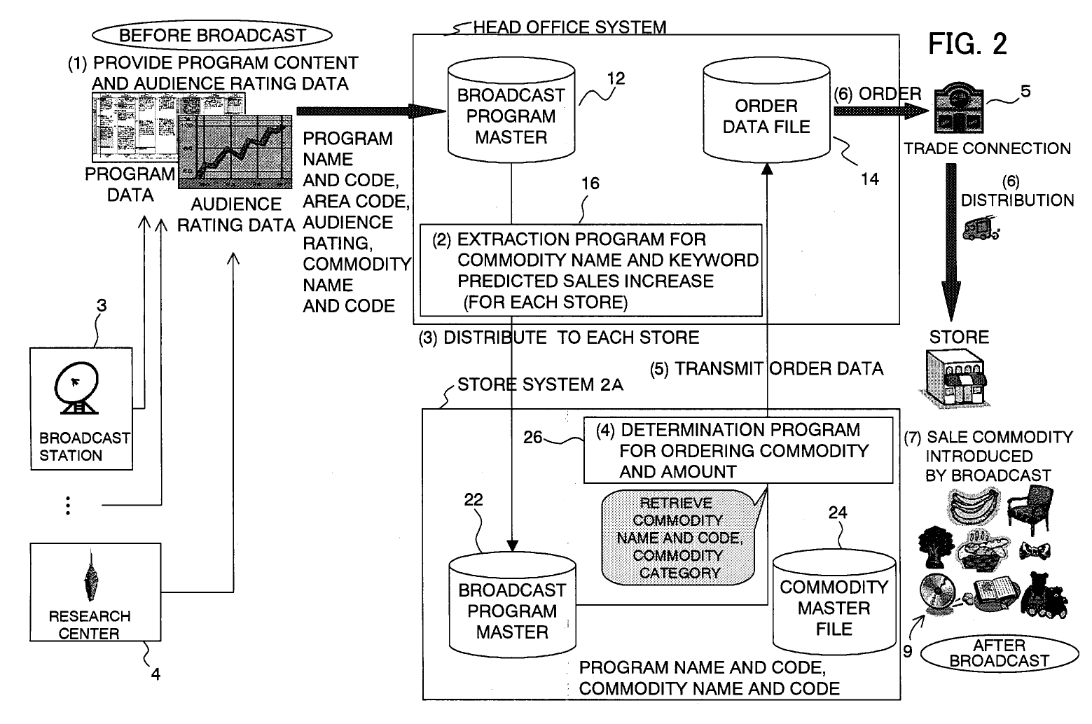

FIG. 1 shows a block diagram of the automatic commodity ordering system as a whole according to one embodiment of the present invention. FIG. 2 shows a process flowchart of the system shown in FIG. 1.

FIG. 1 denotes a distribution store system consisting of stores and a head office system thereof. As shown in FIG. 1, a head office system 1 installed in the head office and store systems 2A, 2B, . . . 2X, 2Y installed in each store are connected to the head office system by a network. The head office system 1 includes various files 12, 14 and a processor (CPU)10 for performing data processing. The file 12 is constituted of a program master file to store broadcast programs and audience ratings as described later. The file 14 is constituted of an order data file for storing order data.

The store systems 2A, 2B, . . . 2X, 2Y also include various files 22, 24 and a processor (CPU) 20 for performing data processing. The file 22 is constituted of a program master file of the store concerned to store broadcast programs and commodity information, as described later. The file 24 is constituted of a commodity master file to store commodities and the number of commodities stocked in the store concerned.

Program data provider 3 is constituted of broadcast stations located in various regions, BS (Broadcast Satellite) stations, CS (Communication Satellite) stations or enterprises thereof, and supplies a broadcast program to the head office system 1 in advance in the form of data. For example, a program is supplied to the head office system 1 in the form of EPG (Electronic Program Guide) before the day of broadcast. A research center 4 researches audience rating of each broadcast program and supplies rating data to the head office system 1. Here, these data are presented according to a contract between the head office and the program data provider 3 or the research center 4.

A trade connection system 5 is provided in each trade connection to which the head office of the distribution stores places orders for commodities. The trade connection system 5 is connected to the head office system 1 to receive a commodity order from the head office system 1. The trade connection distributes a specified commodity 9 of specified quantity to specified store 2A or the like according to the commodity order data.

An overall system processing is explained hereafter referring to FIG. 2.

(1) First, the head office system 1 receives a program data from the program data provider 3 in advance of the program broadcast. The program data before broadcast includes program name, program code, broadcast area code, as well as a commodity name and a commodity code to be introduced in the program. Also, the head office system 1 receives an each measured audience rating data of each broadcast program from the research center 4. This rating data is received in advance of the program broadcast, and therefore the rating data denotes the past rating data of the broadcast program concerned. CPU 10 in the head office system 1 generates the broadcast program master file 12 by combining the received program data with the received rating data. As described later, respective programs, commodities introduced in the programs, and the audience ratings are stored in the broadcast program master file 12.

(2) CPU 10 in the head office system 1 executes an extraction program 16 to extract on a store-by-store basis a commodity name or keyword the sales amount of which can be expected to increase. Generally, it is to be considered that a factor by which sales increase is predictable after broadcast is audience rating. Further, a season of being broadcast or the like is also taken into consideration. Here, the reason for extracting a commodity on a store-by-store basis is that even an identical program may be broadcast in different hours between in the metropolitan and in a local area, and that the commodities dealt in by stores are different. One exemplary case is that store A deals in foods only, while store B deals in foods and clothes, and store C deals in foods and books, etc.

(3) The head office system 1 distributes the extracted commodity name and commodity code on a store-by-store basis to the related store system 2A or the like. The store system 2A or the like store the distributed data into the broadcast program master file 22.

(4) CPU 20 in the store system 2A executes a commodity order determination program 26 at the time of order processing. The commodity order determination program 26 reads out the commodity name or the commodity code from the broadcast program master file 22, and collates with the commodities registered in the commodity master file 24. Thus the commodity order determination program 26 acquires the commodity category (for example, vegetables in foods), and the bland name and the code of the commodity of interest referred to in the trade connection, and then calculates the order amount from the stock amount of the commodity of interest. This order amount is greater than the ordinary stock supplementation amount, to which the amount of expectation in sales increase is added.

(5) CPU 20 in the store system 2A transmits to the head office system 1 the order data including the aforementioned commodity category, bland name, commodity code and the order amount. The head office system 1 stores the order data transmitted from each store into an order data file 14.

(6) CPU 10 the in head office system 1 collects the order data transmitted from each store, classifies on a trade connection-by-connection basis, and places an order (transmit) to the trade connection system 5. The specified commodity of specified quantity is distributed to the specified store on a specified day.

(7) In each store, the commodity introduced in the program is displayed for sale. Thus it becomes possible to prevent the commodity introduced in the program from becoming out of stock, which enables to make use of sales opportunity.

For example, a commodity that will be introduced in a health support program as a commodity recommendable for health is extracted by program data analysis and is placed an order in advance of the broadcast. Thus the commodity can be provided at the store in sufficient quantity after the program is broadcast. This enables to prevent the commodity from being sold out, and at the same time, it becomes possible to promote to increase the sales by clearly expressing that the commodity is the one taken up in the program.

Because program broadcast time as well as area is taken into consideration, it becomes possible to accurately predict the sales amount of the commodity to which sales increase is expected. Further, because the audience rating data is added as a forecast factor, more accurate sales forecast can be achieved.

Moreover, by automatically placing an order for the commodity of which sales increase can be expected, it becomes possible to perform an order job without need of extra work and time by the staff in charge of order processing.

[Automatic Order Processing]

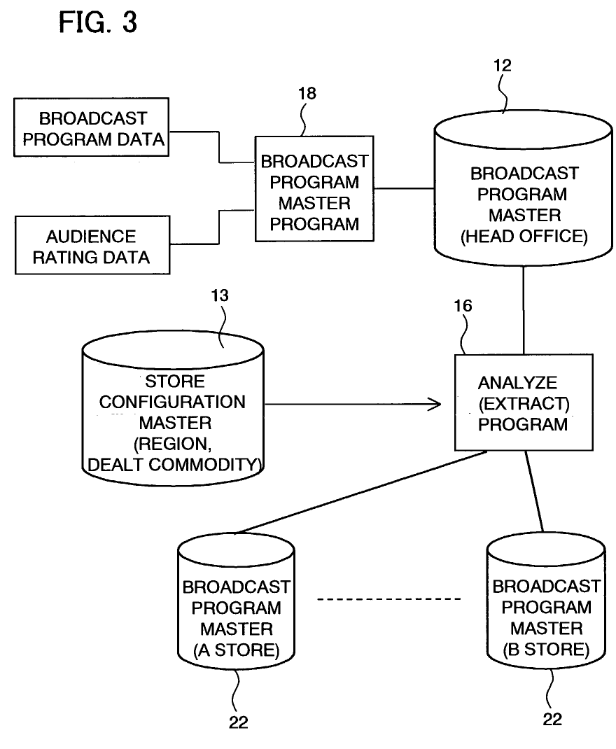

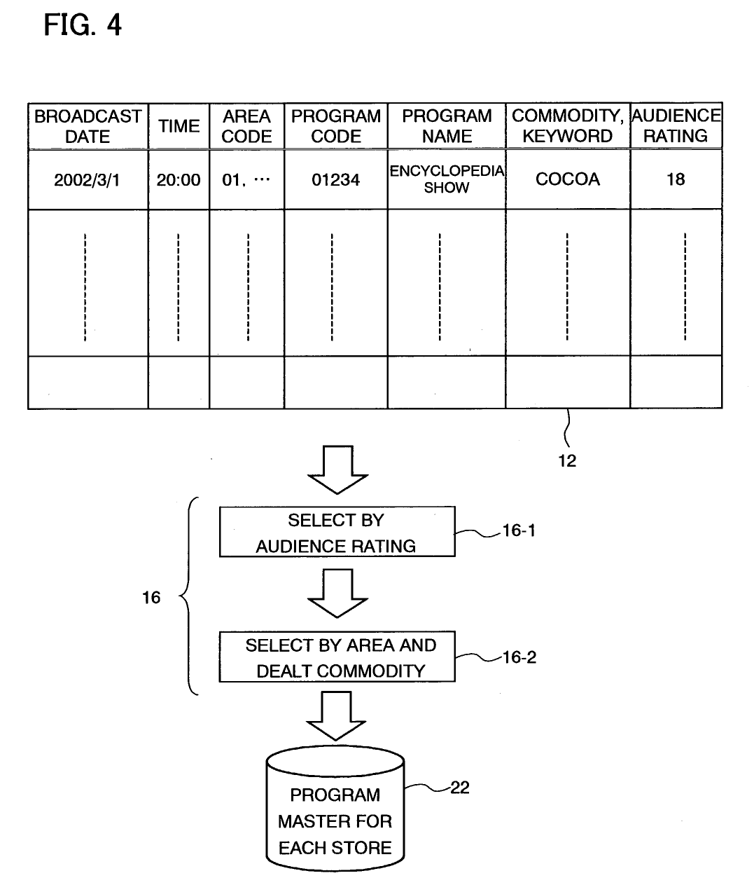

Next, the automatic order processing mentioned earlier is explained in detail referring to FIGS. 3 to 7. FIG. 3 is an explanation drawing of the processing for generating a program master file in the automatic order processing in accordance with the present invention, and FIG. 4 illustrates an analysis processing flow therefor.

As shown in FIG. 3, CPU 10 in the head office system 1 executes a broadcast program master program 18 to generate the broadcast program master file 12 using both the program data received from the program data provider 3 and the audience rating data provided from the research center 4.

As shown in FIG. 4, the program data before broadcast is constituted of broadcast date, broadcast time, program name, program code, broadcast area code, as well as commodity name and keyword to be introduced in the program, etc. For example, in FIG. 4, there is shown a program data of an example in which cocoa is taken up as a food good for health in the health support program titled ‘Encyclopedia Show’. According to this example, the program data includes; broadcast date and time of 1st of March, 2002 at 20:00; program name ‘Encyclopedia Show’; program code ‘01234’; broadcast area code 01 (Kanto region); and commodity name ‘cocoa’.

These program data are received from a broadcasting station, a publishing company of a TV guide magazine, etc. as either electronic data or non-electronic information. In the case of non-electronic information, the information is converted into electronic data in the head office system or any other data service provider. In addition, in the case of a cooking program, cooking materials for use in the cooking program are used as the commodity names, while in an entertainment program, small articles used in the program, clothes worn by performers, compact discs (CD) of theme songs are used as either the commodity names or keywords.

Further, the audience rating data is the past rating data of the broadcast program concerned. Broadcast program master program 18 executed in CPU 10 of the head office system 1 generates the broadcast program master file 12 by combining the received program data with the audience rating data. As shown in FIG. 4, the broadcast program master file 12 stores broadcast date and time, broadcast area, program name and code, commodity introduced in the program and audience rating. In the table of this file 12, the past audience rating is employed as a forecast audience rating of the program concerned before broadcast.

As for this broadcast program master file 12, it is desirable in this example to cover broadcast programs of areas all over the country, or otherwise to cover broadcast programs of the areas in which stores are deployed. Namely, the program data on the programs broadcast by regional broadcast stations, CATV companies, CS/BS service providers are received and registered into a database.

Next, as shown in FIG. 3, CPU 10 in the head office system 1 executes extraction program 16 to extract the commodity name or keyword the sales of which is expected to increase after the broadcast on a store-by-store basis. At this time, broadcast program master file 22 is generated on a store-by-store basis referring to a store configuration master file 13.

The store configuration master file 13 includes data of the installed area of each store (for example, Kawasaki city in Kanto region), and commodity category dealt in by the store concerned (for example, clothing store for the young, grocery, or variety store) registered as a database file.

As shown in FIG. 4, extraction (analysis) program 16 is basically constituted of an extraction processing program 16-1 based on an audience rating, and an extraction program 16-2 based on an area and a commodity category dealt in. Normally a factor of expected sales increase caused by the broadcast is an audience rating. Accordingly, the extraction is carried out by reading out the audience rating of each broadcast program stored in the broadcast program master file 12. Thus broadcast programs having higher audience rating are extracted. In addition, seasonal factor of the broadcast date is also taken into consideration.

The extraction processing program 16-1 by audience rating defines threshold for determining high audience rating and low audience rating to extract broadcast programs having higher audience rating than the defined threshold. For example, an audience rating of 10% is defined as this threshold. A broadcast program having low audience rating will not bring about the commodity introduced in the program to be sold out. Also it is risky to place orders beforehand for the whole commodities which are introduced in every broadcast program. Therefore, the broadcast programs of low audience rating are excluded.

The extraction program 16-2 based on an area of and commodity category dealt in by a store sorts such broadcast programs extracted in the abovementioned manner by areas in which stores are located and business categories recorded in the store configuration master file 13, and generates the broadcast program master file 22 on a store-by-store basis. More specifically, the extraction program 16-2 compares each area in which a store is located with each broadcast area of a broadcast program and also compares each commodity category dealt in by the store concerned with each commodity introduced in the broadcast program. The extraction program 16-2 then extracts a broadcast program that is broadcast in the area in which the store is located and which introduces a commodity dealt in by the store concerned.

For example, in the case a store A is installed in Kawasaki city of Kanto region and deals in foods, any broadcast programs broadcast in areas including Kanto region and food is included as a commodity introduced in the broadcast program are extracted as a broadcast program to be registered into the program master file for store A. The reason for the extraction on a store-by-store basis is that an identical program may be broadcast in different hours between in the metropolitan area and in local areas, and that each store generally deals in commodities of different category. For example, store A deals in foods only, while store B deals in foods and clothes, and store C deals in foods and books, etc.

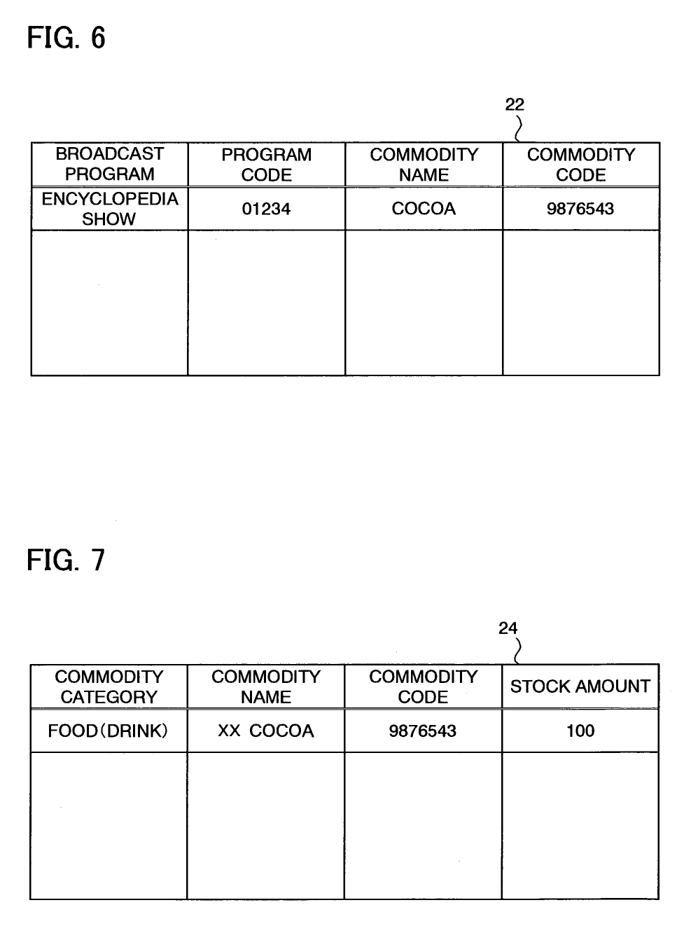

In FIG. 6, an example of the broadcast program master file 22 thus extracted for each store is shown, Here, there is shown an example that the aforementioned program master file extraction processing is carried out on a day or two days before the day of broadcast. The broadcast program master file 22 for each store includes program name, program code, commodity name, and commodity code. This commodity code is assigned by CPU 10 the in head office system 1 from the commodity name introduced in a program. CPU 10 in the head office system 1 distributes the commodity name and commodity code extracted on a store-by-store basis to the related store system 2A or the like. The store system 2A, etc. store these distributed data into the broadcast program master file 22.

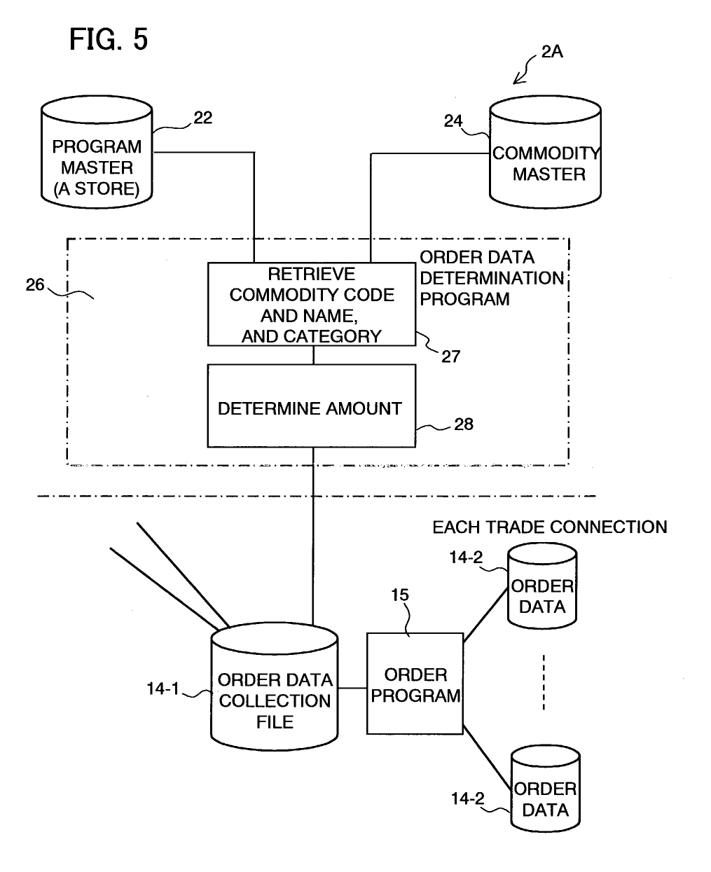

Next, an automatic order processing performed in each store using this program master file is described referring to FIGS. 5 to 7. FIG. 5 shows a flow diagram of a commodity order determination processing. FIG. 6 shows a configuration diagram of the program master file for each store. Also, FIG. 7 shows a configuration diagram of the commodity master file for each store.

A staff in charge of order processing initiates a commodity order determination program 26 to place an order for a commodity at the time of an order processing. The commodity order determination program 26 is constituted of a commodity retrieval program 27 and an order amount determination program 28, in addition to an ordinary commodity order determination program corresponding to an actual sales result.

The commodity retrieval program 27 reads out a commodity name and a commodity code from the broadcast program master file 22 shown in FIG. 6 and collates the commodities stored in the commodity master file 24 shown in FIG. 7, and obtains commodity category (for example, vegetables in foods), and the commodity bland name and the commodity code referred to in the trade connection. The order amount determination program 28 then calculates the order amount from the stock amount of the commodity of interest stored in the commodity master file 24. This order amount is greater than the ordinary stock supplementation amount as a result of adding the forecast amount of expected sales increase.

CPU 20 in the store system 2A transmits to the head office system 1 the order data that include the aforementioned commodity category, bland name, commodity code and the order amount. The head office system 1 stores the order data transmitted from each store into an order data collection file 14-1.

CPU 10 in the head office system 1 then initiates an order connection program 15. This order connection program 15 collects the order data from each store stored in the order data collection file 14-1, classifies on a per order connection (i.e. trade connection) basis, generates an order data file 14-2 for each trade connection (order connection) and placing an order (transmit) to the trade connection system 5. The specified commodity of specified quantity is distributed to the specified store on a specified day.

In the above-mentioned embodiment, order data are collected to ahead office from which orders are transmitted in batches to other trade parties. However, it may also be possible that the orders are transmitted from each store directly to the other trade parties.

Thus, by extracting in advance of the program broadcast the commodity introduced in a broadcast program by program data analysis and placing an order in advance of the broadcast, it becomes possible for a store to provide a sufficient amount of the commodity after the broadcast. This enables to prevent the commodity from becoming out of stock and to protect loss of sales opportunity. Further, it becomes possible to promote the commodity sales by explicitly displaying the commodity at the store representing as the commodity taken up by a program using the program name or the like stored in broadcast program master file 22 for each store.

Also, according to the present invention, broadcast hours as well as broadcast areas are taken into consideration, which enables accurate forecast of the commodity for which sales amount is to be predicted. In addition, an audience rating data is added into a forecast factor, enabling more accurate sales forecast. Moreover, by automatically placing an order for a commodity to which sales increase can be expected, it becomes possible to conduct the order job with reduced labor of the staff in charge of order processing.

[Other Embodiments]

In the foregoing description of the present invention, a retail sales chain store system constituted of a head office and respective stores is taken as an example. However it is also possible to apply the method in a personal store and the like. It is easy to apply the method to such a personal store by constituting a program master file for the head office and providing an external data provider for preparing this program master file.

Additionally, in the case a store maintains customer information, it is possible to promote customers personally to purchase using a direct mail, etc.

To summarize, the method according to the present invention brings about the following effects: Because a commodity to be introduced in a broadcast program is extracted by program data analysis in advance of actual broadcast so as to place an order for the commodity in advance of the program broadcast, the commodity of interest can be provided sufficiently in the store after the program is broadcast. Accordingly, it becomes possible to prevent the commodity from becoming out of stock and thus loss of sales opportunity can be prevented.

Also, an audience rating data is added to a forecast factor, enabling more accurate sales forecast. Moreover, because the commodity the sales increase of which is expectable can be ordered automatically, it becomes possible to conduct the order job with reduced labor of the staff in charge of order processing.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. An automatic commodity order processing method for placing an order for a commodity of which the sales is expected, comprising the steps of:
storing into a database file both a broadcast program data representing broadcast program contents before broadcast and an audience rating of said program broadcast in the past;
retrieving in said database file in advance of said program broadcast and extracting the broadcast program contents having relatively high audience ratings; and
selecting from said broadcast program contents a commodity of which sales amount is expected to increase because of said program broadcast and executing order processing for said selected commodity.

2. The automatic commodity order processing method according to claim 1,
wherein said extraction step comprises the step of regarding said audience rating of the past as an audience rating of said program to be broadcast and extracting the broadcast program contents having higher audience rating than a predetermined threshold.

3. The automatic commodity order processing method according to claim 1,
wherein said storing step comprises the step of registering said broadcast program contents, a broadcast area of said broadcast program and said audience rating data, and
said extraction step comprises the step of extracting broadcast program contents having high audience rating in said broadcast area corresponding to a store location selling said commodity.

4. The automatic commodity order processing method according to claim 1,
wherein said storing step and said extraction step are executed in a head office system, and
said order processing step is executed in a store system to which said extracted broadcast program contents are distributed from said head office system.

5. The automatic commodity order processing method according to claim 1,
wherein said order processing step comprises the step of referring to a stock amount of said commodity stored in a commodity master file and calculating an order amount of said commodity for placing an order.

6. The automatic commodity order processing method according to claim 5,
wherein said order processing step comprises the step of referring to a stock amount of said commodity in a commodity master file provided in a store system and calculating an order amount of said commodity for placing an order.

7. An automatic commodity order processing system for placing an order for a commodity the sales of which is expected, comprising:
a database file stored a broadcast program data representing broadcast program contents before broadcast and an audience rating of said program broadcast in the past; and
a data processor for retrieving in said database file before said program is broadcast, extracting broadcast program contents having relatively high audience ratings, selecting from said broadcast program contents a commodity of which sales amount is expected to increase because of said program broadcast, and executing order processing for said selected commodity.

8. The automatic commodity order processing system according to claim 7,
wherein said data processor regards said audience rating of the past as an audience rating of said program to be broadcast, and extracts broadcast program contents having higher audience rating than a predetermined threshold.

9. The automatic commodity order processing system according to claim 7,
wherein said data base file stores said broadcast program contents, broadcast area and said audience rating data, and
said data processor extracts the broadcast program contents having high audience rating in a broadcast area corresponding to a store location selling said commodity.

10. The automatic commodity order processing system according to claim 7,
wherein said system comprises:
a head office system for registering said database file and extracting said broadcast program; and
a store system to which said extracted broadcast program contents are distributed from said head office system.

11. The automatic commodity order processing system according to claim 7,
wherein said data processor refers to a stock amount of said commodity stored in a commodity master file and calculating an order amount of said commodity for placing an order.

12. The automatic commodity order processing system according to claim 10,
wherein said store system refers to a stock amount of said commodity in a commodity master file provided in said store system and calculating an order amount of said commodity for placing an order.
